(19) United States
(12) Patent Application Publication
(10) Pub. No.: US 2023/0360508 A1
(43) Pub. Date: Nov. 9, 2023

(54) ASSISTED LIVING MONITOR AND MONITORING SYSTEM

(71) Applicant: MYQOL LIMITED, Sale Greater Manchester (GB)

(72) Inventor: Steven MCANENA, Marton, Blackpool Lancashire (GB)

(73) Assignee: MYQOL LIMITED, Sale Greater Manchester (GB)

(21) Appl. No.: 18/246,113

(22) PCT Filed: Sep. 21, 2021
(86) PCT No.: PCT/GB2021/052444

§ 371 Date: Mar. 21, 2023

(30) Foreign Application Priority Data
Sep. 22, 2020 (GB) 2014958.9

(51) Int. Cl. G08B 21/04

(52) U.S. Cl. CPC G08B 21/0469; G08B 21/0492; G08B 21/0461; G08B 21/043

(57) ABSTRACT

An assisted living monitor comprising a pulse density modulation microphone to read noise levels and a processing unit operable to process the noise levels of the pulse density modulation microphone so as to detect changes in noise levels indicative of an anomalous event or activity, wherein the pulse density modulation microphone reads peak to peak noise levels to detect changes in noise levels indicative of an anomalous event or activity.

### CROSS-REFERENCED APPLICATIONS

The present application is a U.S. National Stage Application of International Application No. PCT/GB2021/052444, filed Sep. 21, 2021 and published on Mar. 31, 2022 as WO2022/064182 A1, which claims benefit and priority of Great Britain Patent Application No. 2014958.9, filed on Sep. 22, 2020, each of which is incorporated herein by reference in its entirety for any purpose whatsoever.

### FIELD OF THE DISCLOSURE

The present disclosure relates generally to activity monitoring. In particular, but not exclusively, the disclosure concerns a monitor specifically configured for use in assisted living situations.

### BACKGROUND

The concept of ‘assisted living’ is to be contrasted with ‘controlled living’ which is the type of care typically provided in a nursing home for example.

Residents in a nursing home generally require around the clock care and monitoring. They typically live with more complex health care conditions that require the assistance of a skilled nurse or a physical or speech therapist. Some require respiratory care services.

By contrast, residents in an assisted living community generally require only custodial care or assistance. Assisted living (also known as extra-care housing) offers more support than sheltered housing but still allows the resident to live independently.

A resident in an assisted living facility will typically live in a self-contained flat, with its own front door, with staff usually available up to 24 hours per day to provide personal care and support services. These support services are tailored to the resident and can include help with washing, dressing, going to the toilet and taking medication. Domestic help, such as shopping and laundry, and meals may also be provided.

Common features of assisted living accommodation include:
help from a scheme manager (warden) or a team of support staff
24-hour emergency help through an alarm system.
social activities arranged for the community.
self-contained flats allow you to stay independent.
communal lounges allowing you to socialise as and when you feel like it.

One of the issues faced by an assisted living facility is the monitoring of the residents for safety purposes, particularly as the accommodation is self-contained. Monitoring residents within their own self-contained flat whilst maintaining the resident's privacy is a finely balanced issue. The facility needs to ensure that they are made aware if the resident has a health problem such as a fall, a heart attack or stroke but needs to balance that against the resident's right to privacy.

Potential solutions currently used include wearable devices designed to monitor the health statistics of the resident and fixed emergency call buttons in each room of the self-contained flat. Whilst many wearables are water resistant and can be worn when bathing for example, many are not. An emergency button with a fixed location (or even a portable button) requires that the resident be conscious to operate the button to call for assistance.

Embodiments of the disclosure seek to at least partially overcome or ameliorate any one or more of the abovementioned disadvantages or provide the consumer with a useful or commercial choice.

### SUMMARY

According to a first aspect of the disclosure there is provided an assisted living monitor comprising a pulse density modulation microphone to read noise levels and a processing unit operable to process the noise levels of the pulse density modulation microphone so as to detect changes in noise levels indicative of an anomalous event or activity.

Providing an assisted living monitor (and a system including at least one assisted living monitor) allows remote monitoring of a resident and detection of anomalous events or activities without requiring a visual observation of the resident which is likely to lead to privacy issues.

The assisted-living monitor and/or system is typically configured to monitor a room in an apartment in an assisted living facility in which at least one resident lives.

One or more assisted-living monitors may be provided in a single room in order to effectively and efficiently monitor the room stop the assisted-living monitor is preferably configured to provide information allowing a processing unit two use the information to identify an anomalous event.

The assisted-living system may include additional hardware to provide one or more additional inputs. For example, the assisted-living system may include a pressure pad to be located on a chair or a bed to detect when a resident is seated on the chair or lying on the bed and/or an assistance call button which may be provided in a fixed or portable configuration.

In an embodiment, the simplest type of assisted-living monitor typically includes a pulse density modulation (PDM) microphone to read noise levels. The PDM microphone will typically read peak to peak noise levels to detect changes in peak to peak noise levels. The PDM microphone is preferably configured not to record audio in any detail but simply read the level of noise within the monitored area. The processing unit can then use the captured (peak to peak) noise levels and compare the noise level to the noise level at a historical time. Typically, the noise level used will be the noise level over a period (compared to our historical period) but an instantaneous noise level may be used (compared to a threshold determined to represent an anomalous event).

The comparison may occur between current moment or time period compared to an adjacent moment or time period or a current moment or time period compared to a historical moment or time period which is not adjacent. The comparison is directed at identifying changes in the peak to peak noise level within the monitored area with this significant increase in peak to peak noise level representing an increased likelihood of an anomalous event.

The comparison may be undertaken with a historical time period of the same length, at the same time of day, a previous time period on the same day or on any other basis which increases the likelihood that the change in (peak to peak) noise level indicates an anomalous event occurring.

The comparison will typically be undertaken with historical noise levels in the same room in which the assisted-living monitor is located as different rooms will have different acoustic characteristics.

Use of the (peak to peak) noise levels to identify anomalous events is based upon the principle that an increase in the (peak to peak) noise level is a precursor to an anomalous event in which the resident will require assistance. Typically, the increase in (peak to peak) noise level occurs over a short period of time. A short period of time is typically in the order of a few minutes but may be as short as 5 to 10 seconds.

Preferably, the (peak to peak) noise level captured by the PDM microphone is captured on a real time basis. Typically, the noise level can be output on a display as online trace of noise level over time. This may allow faster identification of increases in the noise level.

The PDM microphone may be analogue but a MEMS PDM microphone is preferred. In one form, an I2S MEMS PDM microphone may be used operating at 8 kHz with 32-bits per sample (128 samples per 20 milliseconds) to provide real-time noise level readings. The values are the typically normalised and amplitude is calculated from the peak to peak values, as the general sensors transmit delay is normally approximately 1000 milliseconds (1 second). The MEMS processor typically stores the highest and lowest values across the 1 second time period and reports this to the processing unit every second.

The assisted living monitor may further comprise at least one thermographic sensor or heat sensor. In an embodiment, the thermographic sensor comprises an array of sensing elements, each operable to output signals corresponding to the temperature of a corresponding segment within the field of view of the thermographic sensor, the processing unit configured to generate an output value matrix from the output signals of each individual sensing element of the thermographic sensor such that when an anomalous event or activity is identified, the output value matrix is used to validate at least one parameter of a living being relative to the assisted living monitor.

The thermographic sensor will typically validate anomalous events or activity relating to a resident rather than other occupants in a space, such as a pet for example.

The thermographic sensor typically collects information which is then processed by the processing unit to provide useful information. In this description, use of ‘thermographic sensor’, particularly in terms of function, is intended to also cover the thermographic sensor in combination with the processing unit, unless the context make is clear that the processing unit is providing additional functionality.

Information from the thermographic sensor may be used to distinguish between a human resident and other heat sources, for example pets or machines and the like. For example, the information from the thermographic sensor may be used to distinguish based on any one or more of: the size of a heat source, the shape of a heat source and temperature of a heat source.

In the context of the present disclosure, the at least one thermographic sensor will typically be used as an alternative to closed-circuit television. Closed-circuit television or any video surveillance equipment will not provide the resident with the privacy to which they are entitled but the use of a thermographic sensor can allow a large amount of information to be captured in relation to the location of the resident within the monitored area and other parameters in relation to the resident such as their body position for example through the use of an optimised definition or resolution of the thermographic sensor. In particular, the definition or resolution of the thermographic sensor which will typically be dependent upon the number of sensing elements in the array, can be optimised to provide sufficient information upon which the processing unit can base a decision as to parameters relating to the resident such as size, shape and body position but also at a low enough resolution or definition so as to be limited to those parameters. In this way, the privacy of the resident is maintained because the thermographic sensor cannot detect enough information to breach the privacy of the resident but sufficient information will be captured in order to be used as a validation of whether or not an anomalous event requiring assistance has occurred based on the peak to peak noise level.

The thermographic sensor is typically configured to provide an indication of the resident location and/or body position of the resident based on the respective temperatures of the segments within the field of view of the thermographic sensor relative to one another.

The thermographic sensor can preferably distinguish between heat sources for example distinguish a resident from a pet from a kettle or oven. Typically, this distinction will be undertaken on the basis of the size and shape of the heat source. Therefore, the thermographic sensor can determine when a resident is in the room, using information such as the size and shape of a heat source but the thermographic sensor can also determine the body position of resident within the room.

In an embodiment, the number of sensing elements provided will typically be configured to provide a block representation of a heat source only to the degree required to conduct a comparison with one or more preset values in order to identify the nature of the heat source, such as whether the heat source is a resident or another heat source such as a pet or appliance for example.

One or more alternatives to the at least one thermographic sensor may be used. Such alternatives include a 3D Time-of-Flight (ToF) sensor or camera such as a single-photon avalanche diode (SPAD) or a LiDAR sensor or camera. A structured light sensor could be used to determine physical position and posture within the target area. All of these alternatives provide 3D depth sensing. The alternatives may also provide the ability to produce a visual image. Where some LiDAR or Time-of-Flight sensors or cameras may have one measurement point or several on a SPAD, preferred sensors or cameras may receive hundreds from a wide field of view at a very fast rate.

Data from any of the alternatives may be overlayed across the thermographic data to provide a depth resolution not possible with at least one thermographic sensor alone.

The data supplied by a structured light sensor is generally known as a 3D Point Cloud. This 3D Point Cloud data may allow further analysis of the scene by means of additional algorithms and determine if a possible fall event has occurred within the target area. This Point Cloud Data may also allow the system to disregard erroneous thermal heat sources allowing for a more accurate result.

Information from the at least one thermographic sensor and/or alternative can be used in combination with the peak to peak noise levels from the PDM microphone. In an embodiment, the PDM microphone of the assisted-living monitor is used to identify the occurrence of anomalous events based on changes to the peak to peak noise level. The data from the at least one thermographic sensor and/or alternative can then be used to examine the monitored area for the presence of a resident and if a resident is present, then the location and/or body position of the resident which may be indicative of a fall or similar.

In an embodiment, information from the at least one thermographic sensor may be used to electronically produce a visual image (which can be displayed for a user for example), based on the output signals corresponding to the temperature of the corresponding segment. The electronic image will typically be a block image with each block relating to the temperature from one of the array of sensing elements. Each of the blocks may be a pixel with the shade or colour of the pixel representing the temperature in the corresponding segment.

Importantly, any block image created will be a low-resolution block image sufficient to indicate the location and/or body position of a resident but insufficient to read any relevant details which may breach the privacy of the resident. The block image can be used to provide information in relation to the size and/or shape and/or location and/or body position of a heat source.

The block image can be used to validate the anomalous event or activity by checking for the presence of the resident first and then the location/body position of resident. Use of the information relating to the noise levels from the PDM microphone and the thermographic information from the thermographic sensor and/or an alternative as outlined above, will typically increase the accuracy of the assessment of the anomalous event.

Any type of thermographic sensor could be used. A number of thermographic sensors may be used. As mentioned, typically the number of sensing elements in the array of sensing elements of the at least one thermographic sensor will preferably correspond to the number of blocks in the resolution of the preferred image which is generated.

In an embodiment, the at least one thermographic sensor and/or alternative, may collect data in a higher resolution than that used to generate and display the image. The processing unit may use an averaging algorithm if the data is collected in a higher resolution than that to be used.

In an embodiment, the output from the at least one thermographic sensor and/or alternative is typically not visible unless selected. The detection of an anomalous event is typically undertaken at a primary level by the PDM microphone and changes to the peak to peak noise level and the information from the at least one thermographic sensor or alternative may then be displayed when an anomalous event is detected by the PDM microphone.

At least one thermographic sensor may be used in building/rooms which do not have floor heating. The at least one thermographic sensor may be fitted between 400 mm and 600 mm from finished floor level.

A 3D Time-of-Flight (ToF) sensor or camera such as a single-photon avalanche diode (SPAD) or a LiDAR sensor or camera may be used in building/rooms which have floor heating. These types of sensors may be fitted between 100 mm and 150 mm from finished floor level.

The assisted living monitor may further comprise at least one movement sensor operable to detect movement. The at least one movement sensor will preferably sense movement and provide information to the processing unit of the assisted living monitor. The at least one movement sensor may be the at least one thermographic sensor as the information collected by the at least one thermographic sensor may be used to detect movement of the heat source.

The at least one movement sensor preferably allows determination of physical movement without constant observation. The at least one movement sensor and/or the processing unit can preferably determine rough distance and speed of movement over time. This may be stored and/or displayed in a line trace for example, which will allow monitoring but maintain privacy for the resident. This information can then be used in combination with the peak to peak noise levels from the PDM microphone and/or the output signals corresponding to the temperature from the thermographic sensor to more accurately characterise an activity or event relating to a resident as an actionable anomalous event or activity, or an anomalous event or activity that does not require action.

The at least one movement sensor will typically detect anomalous events or activity relating to a resident rather than other occupants in a space, such as a pet for example.

Typically, the at least one movement sensor utilises the Doppler effect to determine movement within the monitored area. Any type of movement sensor may be used. Any number of movement sensors may be used. Typically, a single movement sensor is used in order to detect movement relative to a single location of the assisted living monitor. More than one movement sensor may be used in order to increase the accuracy of the system in detecting movement and/or other information such as the direction of movement for example. A radar sensor may be used. A microwave radar sensor could be used.

As mentioned above, the information from the at least one movement sensor may be used combination with the peak to peak noise levels of the PDM microphone and/or the information from the at least one thermographic sensor to provide more information to the processing unit in order to validate the anomalous event as either an anomalous event in which the resident requires assistance on anomalous event in which the resident does not require assistance.

The at least one movement sensor can detect the mobility of resident which when coupled with the information from the thermographic sensor, may give increased accuracy in identification of the presence of a resident within the monitored area and/or in identifying a resident as a resident as compared to another heat source which may be similarly shaped but immobile for example.

Information from the at least one movement sensor will preferably be combined with the peak to peak noise level information collected by the PDM microphone in order to detect the occurrence of an anomalous event and also the source of the anomalous event. Once on anomalous event has been detected and the source of the anomalous event has been detected, the thermographic information can then be used to validate the anomalous event as one in which the resident requires assistance or not.

Therefore, in an embodiment, the information collected from the PDM microphone may be used by itself or preferably in combination with the information from the at least one movement sensor as basic information to detect the occurrence of an anomalous event and/or the source of the anomalous event and then the information from the at least one thermographic sensor is preferably used in combination with the basic information to validate the nature of the anomalous event as one in which the resident requires assistance or not.

The processing unit may include an algorithm which is capable of determining a rough distance of a movement from the at least one movement sensor. The processing unit may be capable of determining a speed of movement based on information collected from the at least one movement sensor.

An output from the at least one movement sensor may be displayed on a visual display as a line trace over time.

Typically, all of the components of the assisted living monitor are provided in a housing. The housing is typically configured to be mounted within a room of an apartment or flat for example of an assisted living facility. Normally, a processing unit is provided on board the assisted living monitor together with the one or more sensors. If provided as a part of a larger system, a central system controller may be provided.

According to a second aspect, there is provided an assisted living monitor system comprising a pulse density modulation microphone to read noise levels and a processing unit operable to process the noise levels of the pulse density modulation microphone so as to detect changes in noise levels indicative of an anomalous event or activity.

In an embodiment, the processing unit may be provided remotely from the pulse density modulation microphone. The pulse density modulation (PDM) microphone may read peak to peak noise levels.

The system may further comprise at least one thermographic sensor and/or at least one movement sensor.

In the second aspect, the microphone, at least one thermographic sensor and at least one movement sensor may be provided in one housing within a room or separate housings but will each (if provided in the system) provide information to the processing unit in order that the processing unit can use the information to assess situations.

According to a third aspect of the disclosure there is provided an assisted living monitor system comprising a pulse density modulation microphone as described above provided in each of at least a living area, bedroom and bathroom of a residential area, each assisted living monitor associated with at least one communication pathway, a processing unit operable to process the peak to peak noise levels of the pulse density modulation microphone so as to detect changes in noise levels indicative of an anomalous event or activity and at least one monitoring system display located externally of the residential area with access to each of the assisted living monitors for the residential area.

Providing an assisted living monitor comprising a pulse density modulation (PDM) microphone to read noise levels of the microphone so as to detect changes in noise levels and to categorise activity within an area according to the peak to peak levels, allows monitoring but also maintains privacy for the resident. If an anomalous event or activity is detected using the peak to peak noise levels as a basic detector, then the processing unit can validate the anomalous event or activity using one or more of the output signals corresponding to the temperature of a corresponding segment within the field of view of the thermographic sensor and/or data from the at least one movement sensor to more correctly characterise the anomalous event or activity relating to a resident as an actionable event or activity, or an anomalous event or activity that does not require action.

The pulse density modulation (PDM) microphone may read peak to peak noise levels.

A central system control may be provided to which all of the assisted living monitors in an apartment feed information. The central system control may then provide a visual output of the information from each assisted living monitor in an apartment in a summary display.

The position of the assisted living monitor within the room will typically depend upon the room in which it is mounted. For example, when an assisted living monitor is mounted in a living area or a bedroom, the assisted living monitor can be mounted in an upper region of the room, preferably relative to a ceiling or an upper position on a wall. Normally, the assisted living monitor will be oriented in a particular direction. The one or more sensors in the assisted living monitor will typically have a field of view and the assisted living monitor is typically located within the room such that the field-of-view is directed at parts of the room it which a resident would normally use. In an embodiment, an assisted living monitor can be located in a corner of a room. In an embodiment, an assisted living monitor can be located in a central location on a wall and director at commonly used implements within the room such as a bath, toilet are so far a bed and the like. It must be stressed however that the position of the assisted living monitor within the room will be dependent not only on the room, but also the location of furniture within the room or implements within the room and the field-of-view of the one or more sensors.

Information which is sensed by the one or more sensors and/or produced by the processing unit will typically be stored, normally electronically. Typically, the information is stored in a central storage facility.

The information which is sensed can be displayed on a display which is external to the apartment. For example, an electronic display may be provided immediately adjacent to the door to the residents apartment and information in relation to the assisted living monitors within the apartment displayed on that display so that staff of the assisted living facility can monitor the activity within the apartment without entry to the apartment and without breaching the privacy of the residents. Normally, a display which is outside an apartment is dedicated to that particular apartment.

A central system control may be provided with one or more displays on which information in relation to all the apartments and the facility can be accessed.

A software application may be provided. The software application may have a monitoring subsystem which operates at all times to monitor information collected from each sensor of the assisted living monitor and if more than one assisted living monitor is provided in a system, for each sensor of each assisted living monitor. The monitoring subsystem will typically collect information and display the information on a relevant display. As mentioned above, a display may be provided externally from the apartment in an assisted living facility such as a door display. A central display may display information in relation to more than one apartment (but allow detailed information in relation to each apartment when an apartment is selected).

The software application may have an alert subsystem in order to detect anomalous events. The alert subsystem will typically operate concurrently with the monitoring subsystem. The alert subsystem will typically validate an anomalous event as an event in which a resident of likely to require action or assistance or not. The validation step will typically take place once an anomalous event has been detected.

Information from one or more assisted living monitors may be displayed on a summary interface. The summary interface is preferably provided on a display such as a touchscreen which allows action to be taken in relation to the interface and/or on a conventional screen with appropriate input hardware. The summary interface will typically allow the user to drill down to different apartments within a facility, each room within an apartment, and potentially each sensor in an assisted living monitor provided in a particular room.

Normally, a software application will display a line trace of the peak to peak noise levels collected over time from the PDM microphone. Normally, the software application will display a visual indicator of where the movement is detected by an assisted living monitor. If additional hardware such as pressure pads are provided on one or more chairs or beds for example the software application will typically display a visual indication of information from the pressure pad which typically indicates that a resident is currently sitting/lying on a chair/bed.

The visual indicators may be simple colour code indicators with one colour indicating a positive and another colour indicating a negative as this will allow more information to be displayed in a small area using one or more icons and a colour coding system. An operator or staff member may be able to select a particular room within a particular apartment and then produce a more detailed view of information in relation to that particular room. The more detailed view may include information such as the noise level trace from the PDM microphone, noise level data, movement data and/or thermographic information.

Therefore, the information from the PDM microphone will preferably be collected to allow the identification of anomalous events and information from a movement sensor and/or thermographic sensor may be used to give a powerful indicator of the nature of an event and/or additional information on the location and/or body position of the resident.

Use of information from all three types of sensor together will typically allow a more accurate characterisation of an anomalous event once an anomalous event has been detected and provide an indication of whether the resident requires assistance or not without disrupting the resident, and maintaining the privacy without the need for monitoring equipment that produces a visual image of each room such as CCTV.

The assisted living system may be used in association with an emitter unit for use in a sensory room environment, the emitter unit comprising a mounting portion, at least one projector device mounted relative to the mounting portion and at least one light emitting halo located about the at least one projector or a sensory room system including at least one emitter unit comprising a mounting portion, at least one projector device mounted relative to the mounting portion to project at least a portion of a visual display on at least one wall of the room, at least one light emitting halo located about the at least one projector and a controller to control the at least one projector device and the at least one light emitting halo to operate in synergy.

The assisted living monitor will preferably be mounted within the room so as not to obstruct the visual display on at least one wall of the room by the at least one emitter unit. Provision of the assisted living system in association with an emitter unit for use in a sensory room environment will assist with management/treatment of a resident whilst also monitoring the resident, to form a holistic system for resident.

### DETAILED DESCRIPTION

In order that the disclosure may be more clearly understood one or more embodiments thereof will now be described, by way of example only, with reference to the accompanying drawings, of which:

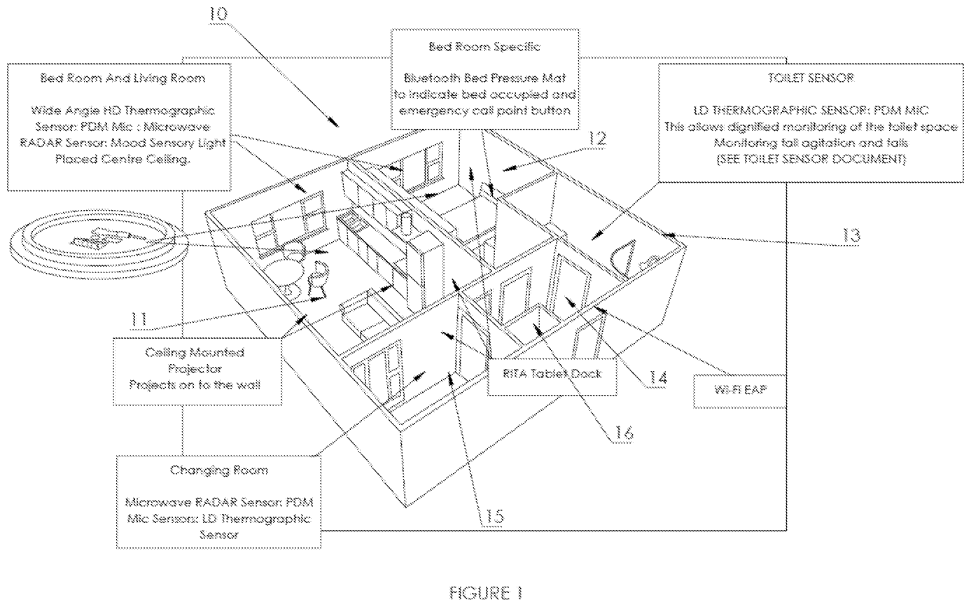

FIG. 1 is an axonometric view of an example of a self-contained flat with an assisted living monitor of an embodiment fitted to multiple rooms therein.

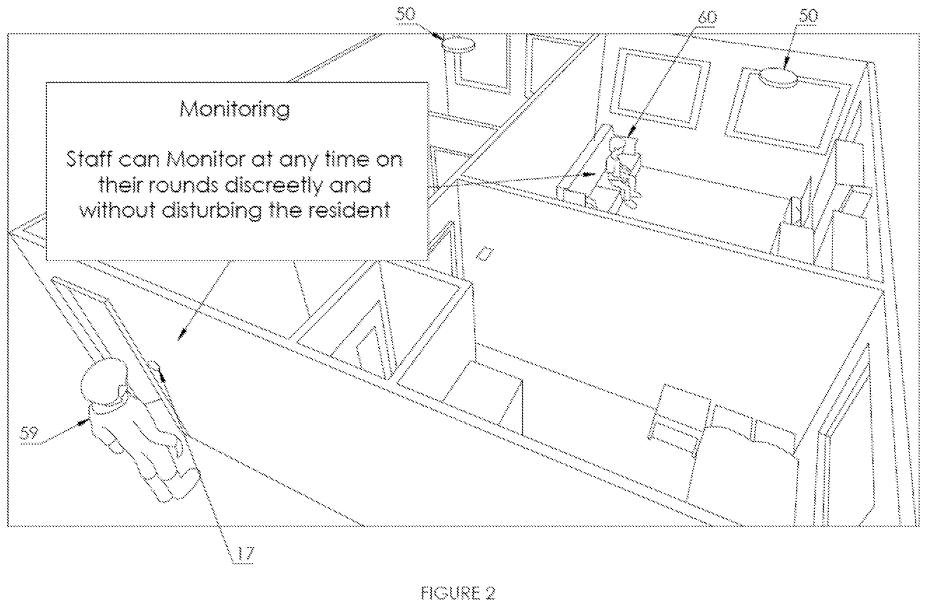

FIG. 2 is an axonometric view of the self-contained flat shown in FIG. 1 with an externally mounted display screen in communication with the assisted living monitors.

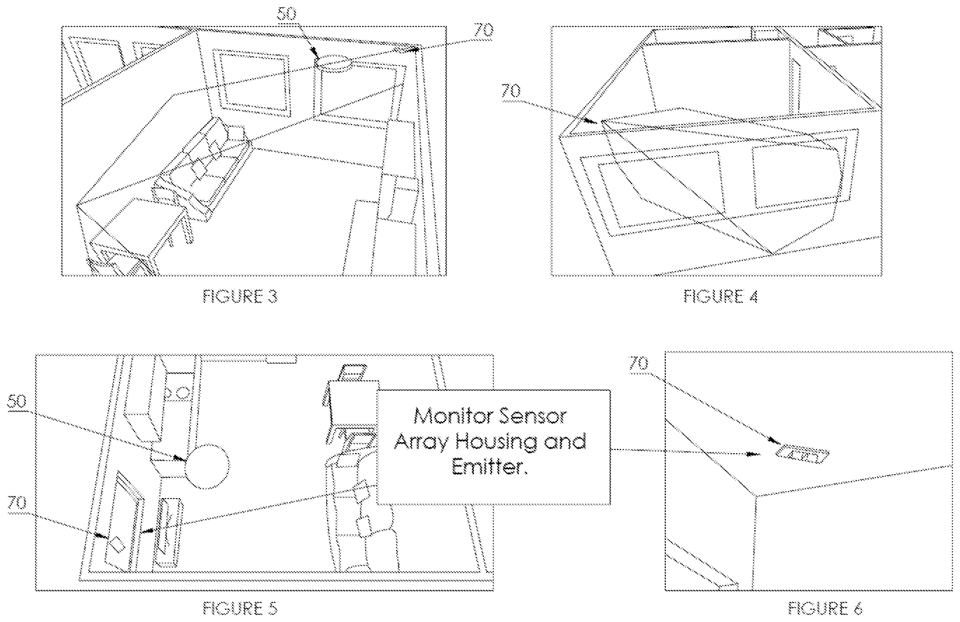

FIG. 3 is an axonometric view of a living room of the self-contained flat shown in FIG. 1 and showing the area monitored by the assisted living monitor.

FIG. 4 is a reverse view of that shown in FIG. 3.

FIG. 5 is an axonometric view of a living room of the self-contained flat shown in FIG. 1 and showing the position of the assisted living monitor in an embodiment.

FIG. 6 is an axonometric view of the configuration in FIG. 5 showing the ceiling mount.

FIG. 7 is an axonometric view of the configuration in FIG. 5 showing the orientation of the assisted living monitor.

FIG. 8 is an axonometric view of a toilet room with an assisted living monitor of an embodiment and showing the area monitored.

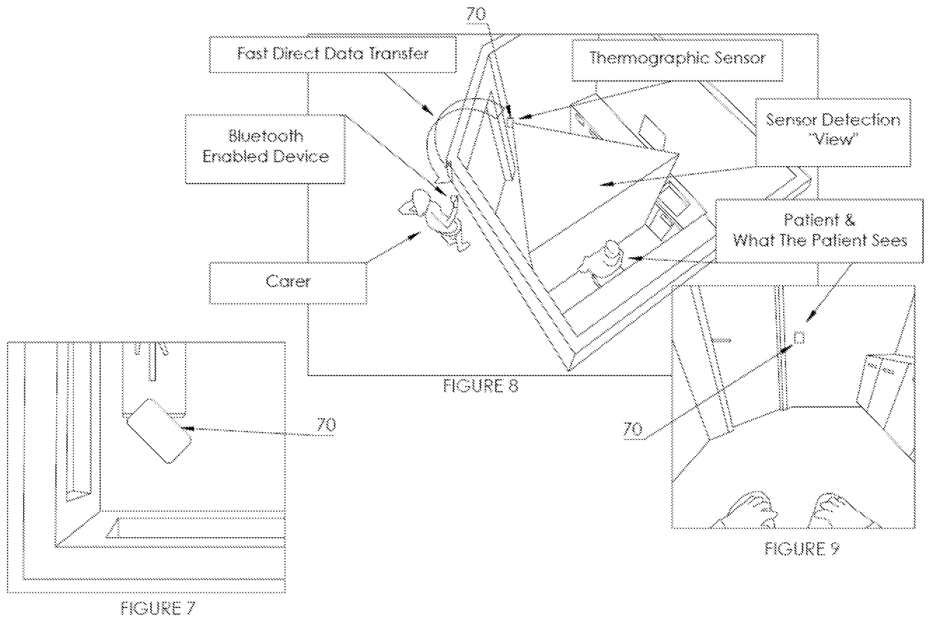

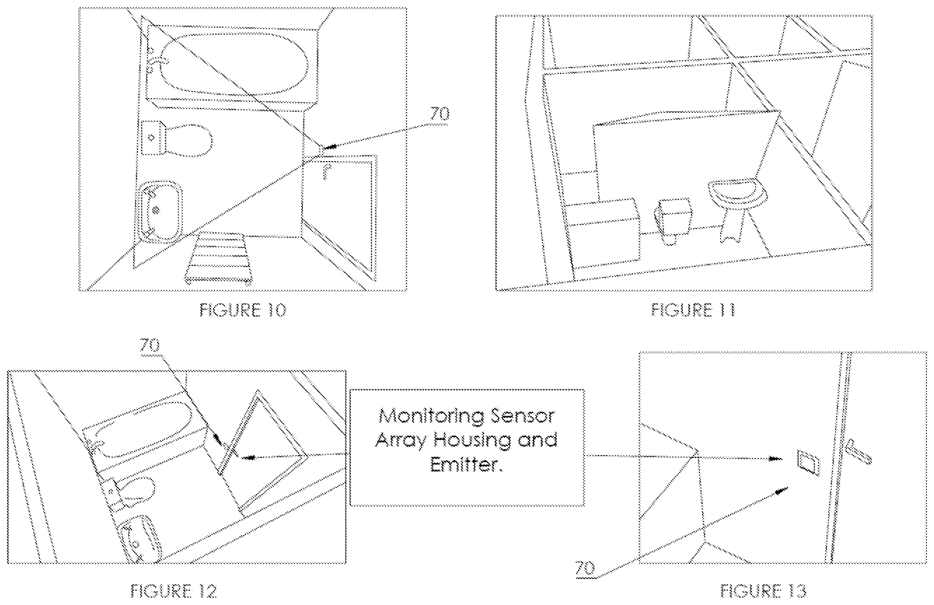

FIG. 9 is an illustrative view showing the resident view from the toilet in the configuration illustrated in FIG. 8.

FIG. 10 is a plan view of a wet room showing an assisted living monitor location in an embodiment.

FIG. 11 is a view from behind the wet wall in the configuration shown in FIG. 10.

FIG. 12 is an axonometric view of the configuration illustrated in FIG. 10.

FIG. 13 is a detailed view of the assisted living monitor location in the configuration illustrated in FIG. 10.

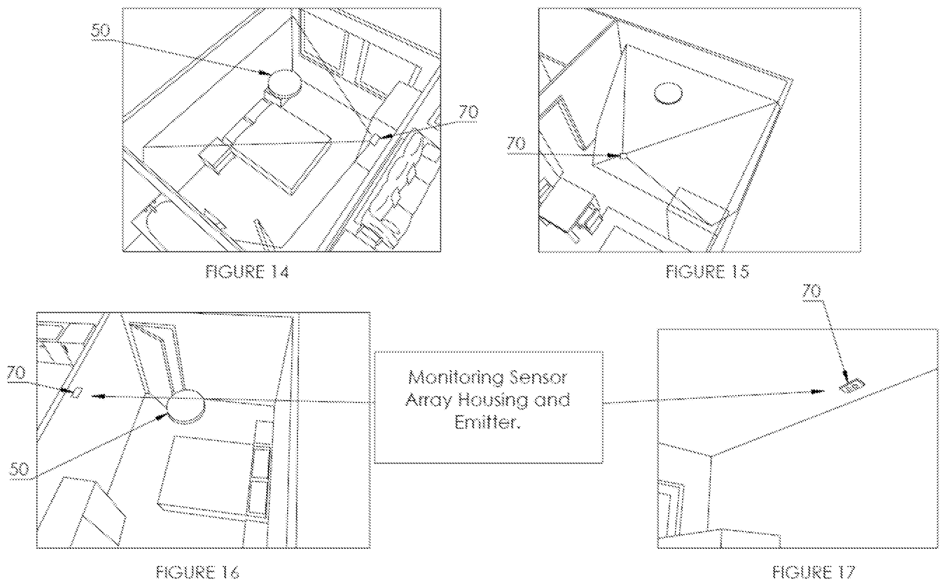

FIG. 14 is an axonometric view of a bedroom with an assisted living monitor of an embodiment and showing the area monitored.

FIG. 15 is a view from behind the assisted living monitor in the configuration illustrated in FIG. 14.

FIG. 16 is an axonometric view of the configuration illustrated in FIG. 14 showing the assisted living monitor location.

FIG. 17 is a detail view of a possible bedroom configuration showing a ceiling mount.

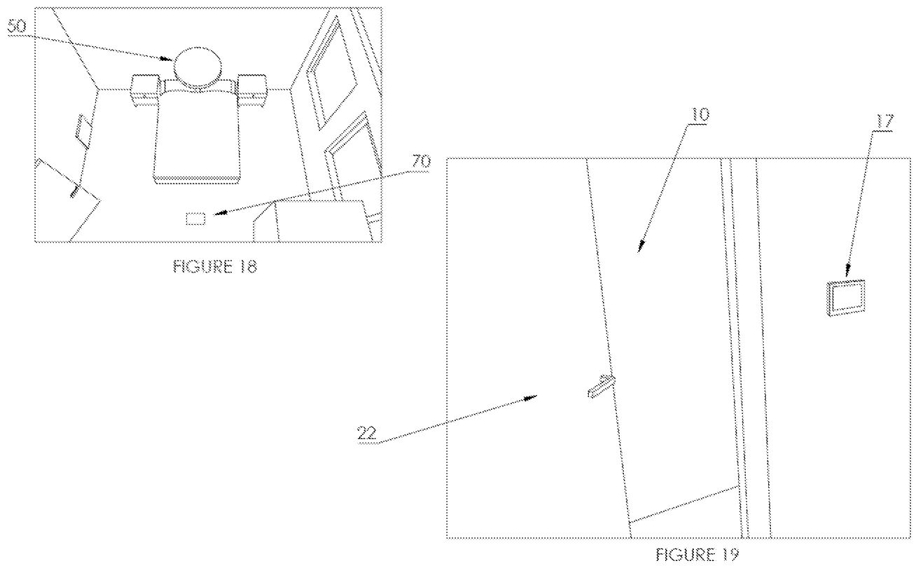

FIG. 18 is a plan view of the configuration shown in FIG. 14.

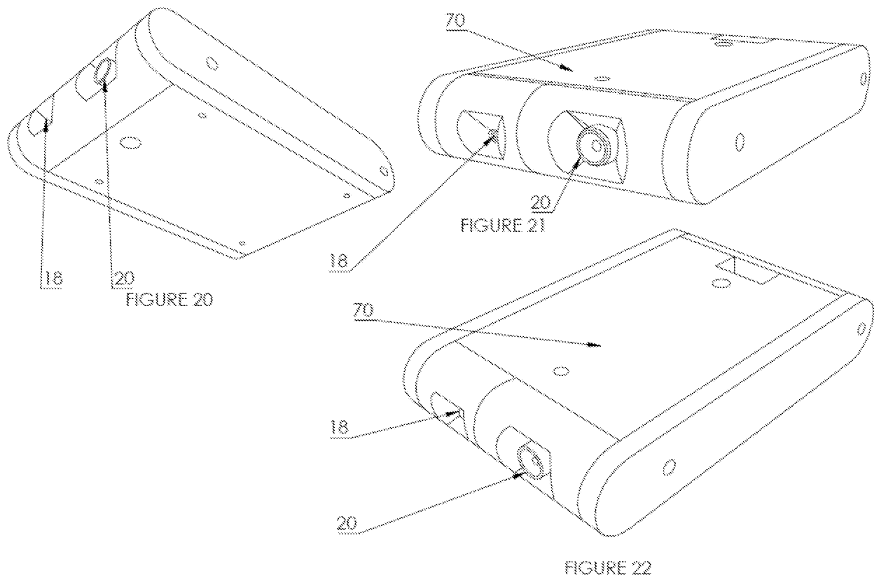

FIG. 19 is an elevation view of an externally mounted display screen as shown in FIG. 2.

FIG. 20 is an axonometric view from an underside of an assisted living monitor according to an embodiment.

FIG. 21 is an axonometric view from the front of the assisted living monitor as shown in FIG. 20.

FIG. 22 is an axonometric view from the top of the assisted living monitor as shown in FIG. 20.

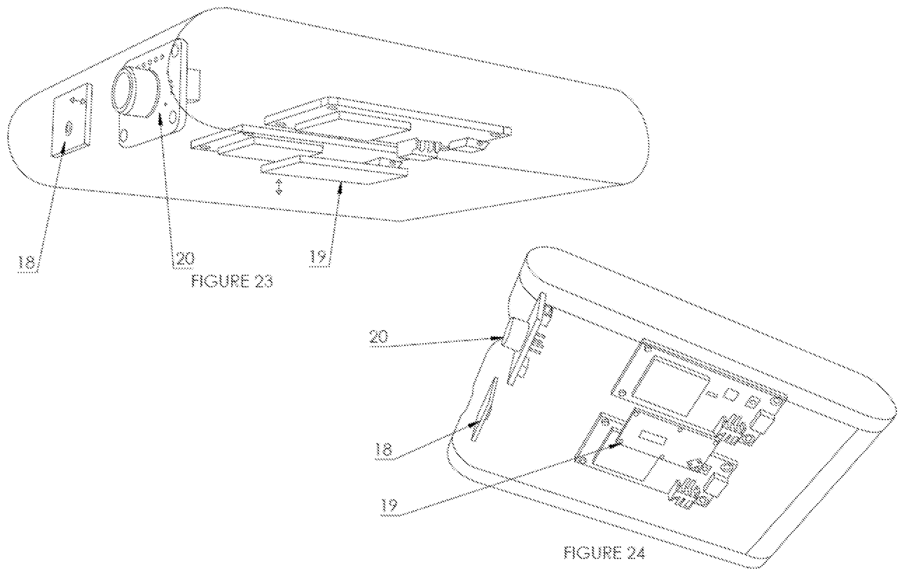

FIG. 23 is a partially transparent side view of the assisted living monitor as shown in FIG. 20.

FIG. 24 is a partially transparent bottom view of the assisted living monitor as shown in FIG. 20.

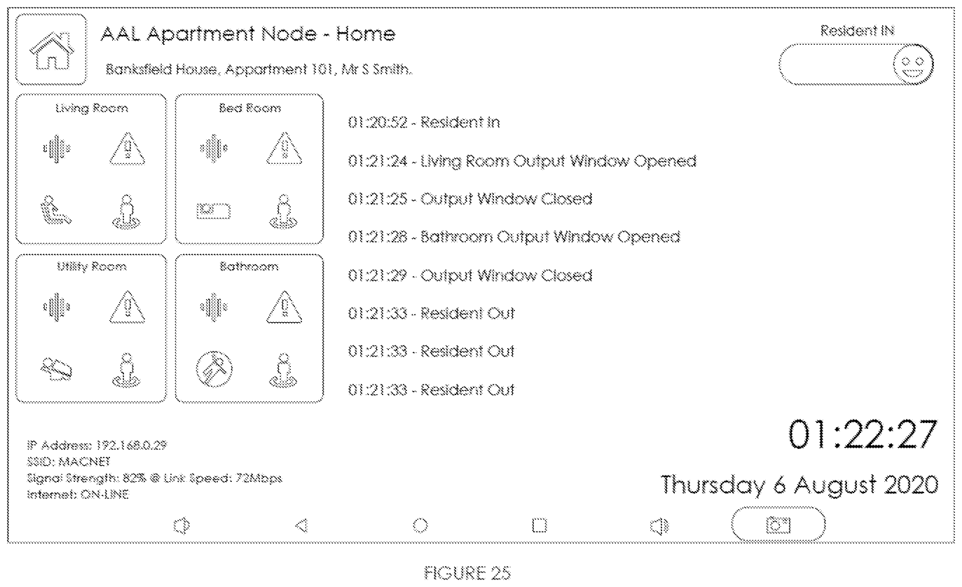

FIG. 25 shows an example home interface of a display of the externally mounted display screen shown in FIG. 19.

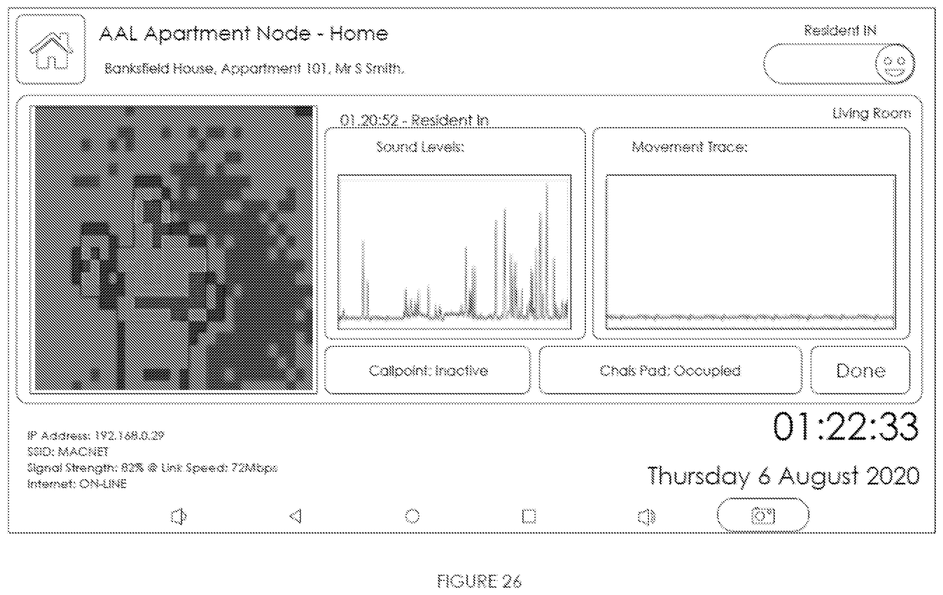

FIG. 26 shows an example room detail interface of a display of the externally mounted display screen shown in FIG. 19.

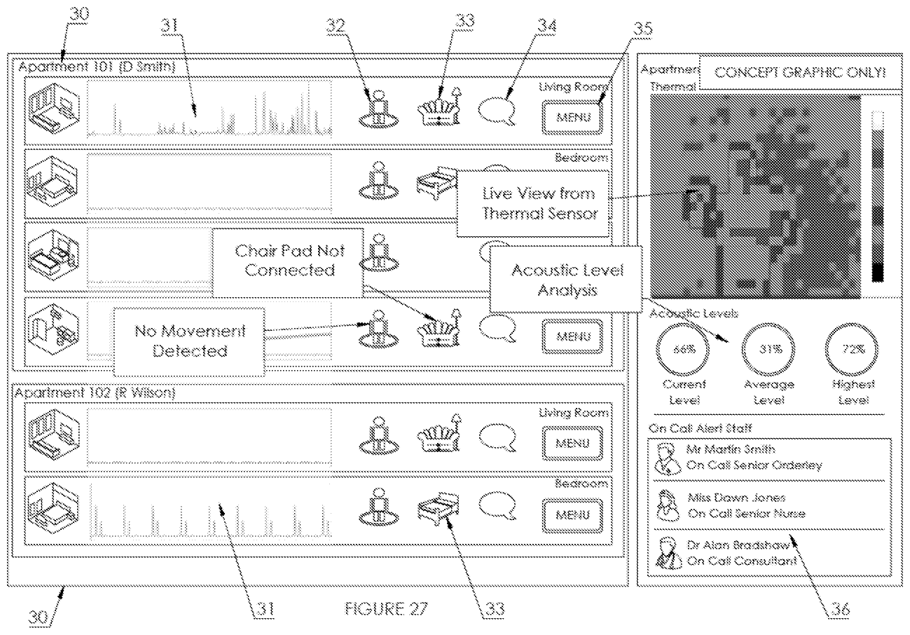

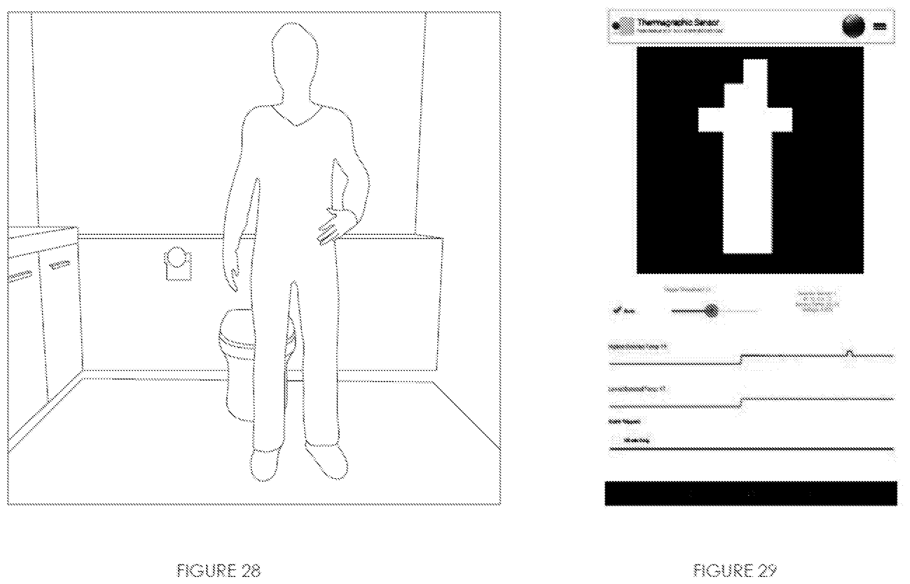

FIG. 27 shows an example apartment interface of a display of a central monitoring location in an assisted living facility according to an embodiment.

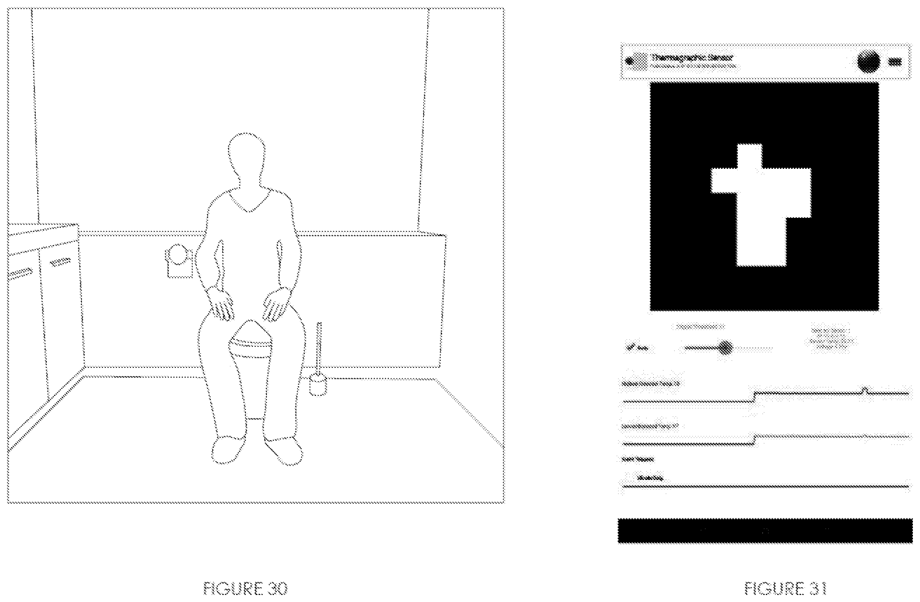

FIG. 28 is a front view of a resident standing in a wet room; and

FIG. 29 shows an output value matrix, highest temperature recorded, lowest temperature recorded and alerts triggered display from a thermographic sensor according to an embodiment corresponding to the resident shown in FIG. 28.

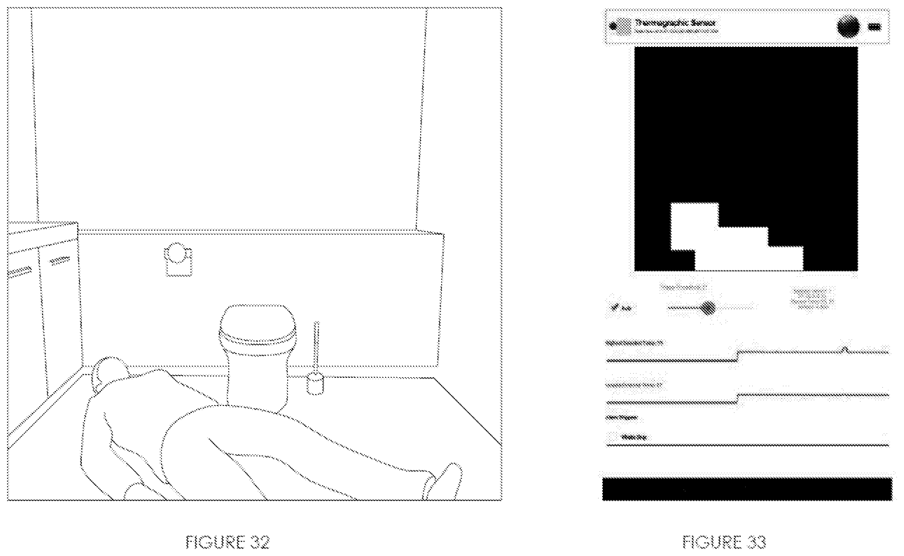

FIG. 30 is a front view of a resident sitting in a wet room; and

FIG. 31 shows an output value matrix, highest temperature recorded, lowest temperature recorded and alerts triggered display from a thermographic sensor according to an embodiment corresponding to the resident shown in FIG. 30.

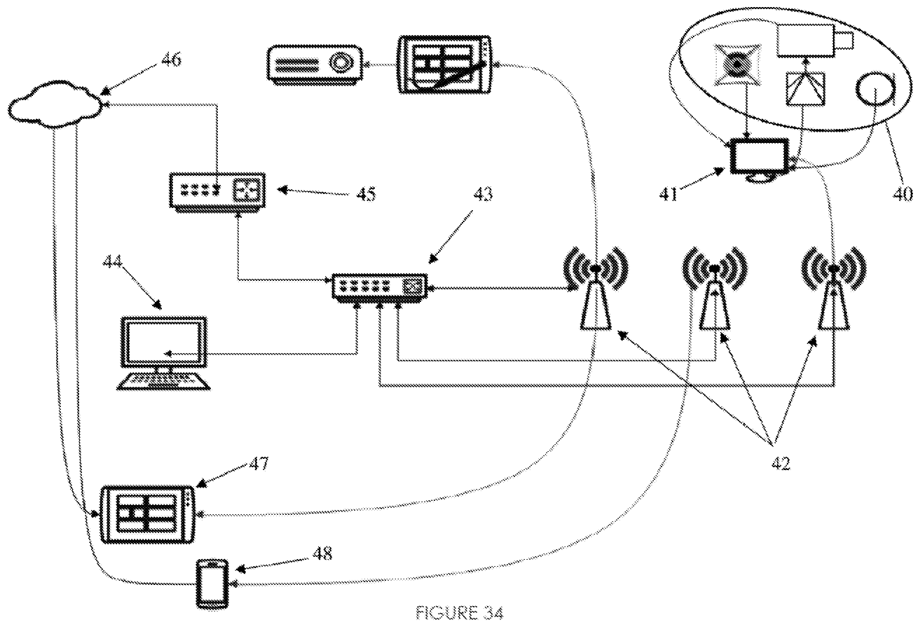

FIG. 32 is a front view of a resident on the floor in a wet room; and

FIG. 33 shows an output value matrix, highest temperature recorded, lowest temperature recorded and alerts triggered display from a thermographic sensor according to an embodiment corresponding to the resident shown in FIG. 32.

FIG. 34 is a schematic illustration of an assisted living monitor system according to an embodiment.

With reference to the accompanying figures, an assisted living monitor, such as that illustrated in FIGS. 20 to 24, comprising a pulse density modulation (PDM) microphone 18 to read peak to peak noise levels and a processing unit 19 (within the preferred housing) operable to process the peak to peak noise levels of the PDM microphone 18 so as to detect changes in noise levels indicative of an anomalous event or activity, is provided.

The assisted-living monitor and/or system is typically configured to monitor a room in an apartment in an assisted living facility in which at least one resident lives. An example of an apartment is illustrated in FIG. 1

The example apartment 10 shown in FIG. 1 includes a main living room 11, a bedroom 12, a bathroom 13, a utility room 14, a changing room 15 and a server/control room 16.

One or more assisted-living monitors may be provided in a single room in order to effectively and efficiently monitor the room. The assisted-living monitor is preferably configured to provide information allowing a processing unit to use the information to identify an anomalous event.

The assisted-living system may include additional hardware to provide one or more additional inputs. For example, the assisted-living system may include a pressure pad to be located on a chair in the living room 11 or a bed in the bedroom 12 to detect when a resident is seated on the chair or lying on the bed and/or an assistance call button which may be provided in a fixed or portable configuration.

The apartment 10 is typically fitted with a display screen 17 adjacent to the main entry door of the apartment as illustrated in FIG. 2. The display screen will preferably display a summary of the information from the assisted-living monitors within the apartment. An example of such a display is shown in FIG. 25. The example interface shows an output from each of the rooms in s summary form using icons and colour coding of the icons to indicate the status of the resident and/or activity in the room. The interface also shows whether the resident is in the apartment. Still further, the interface shows that the system includes window and door sensors (in addition to the assisted-living monitors) which provide an indication of when windows and doors are opened and closed. Using this display screen 17, which is located outside the apartment 10 so as to maintain the private living space of a resident 60 as private, a staff member 59 in an assisted living facility in which the apartment 10 is located can monitor the resident 60 inside the apartment from the outside.

In an embodiment, the simplest type of assisted-living monitor 70, one example of which is illustrated in FIGS. 20 to 24, typically includes a pulse density modulation (PDM) microphone 18 to read peak to peak noise levels. The PDM microphone 18 is configured not to record audio in any detail but simply read the level of noise within the monitored area. The processing unit 19 can then use the captured peak to peak noise levels and compare the noise level to the noise level at a historical time. Typically, the noise level used will be the noise level over a period (compared to our historical period) but an instantaneous noise level may be used (compared to a threshold determined to represent an anomalous event).

The comparison may occur between current moment or time period compared to an adjacent moment or time period or a current moment or time period compared to a historical moment or time period which is not adjacent. The comparison is directed at identifying changes in the peak to peak noise level within the monitored area with this significant increase in peak to peak noise level representing an increased likelihood of an anomalous event.

The comparison may be undertaken with a historical time period of the same length, at the same time of day, a previous time period on the same day or on any other basis which increases the likelihood that the change in peak to peak noise level indicates an anomalous event occurring.

The comparison will typically be undertaken with historical peak to peak noise levels in the same room in which the assisted-living monitor 70 is located as different rooms will have different acoustic characteristics.

Use of the peak to peak noise levels to identify anomalous events is based upon the principle that an increase in the peak to peak noise level is a precursor to an anomalous event in which the resident will require assistance. Typically, the increase in peak to peak noise level occurs over a short period of time. A short period of time is typically in the order of a few minutes but may be as short as 5 to 10 seconds.

Preferably, the peak to peak noise level captured by the PDM microphone 18 is captured on a second by second or real time basis. Typically, the peak to peak noise level can be output on a display as online trace of noise level over time such as that shown in FIG. 27 for example. This may allow faster identification of increases in the peak to peak noise level.

The assisted living monitor 70 illustrated in FIGS. 20 to 24 also includes at least one thermographic sensor 20 or heat sensor. A preferred thermographic sensor includes an array of sensing elements, each operable to output signals corresponding to the temperature of a corresponding segment within the field of view of the thermographic sensor. The processing unit 19 is configured to generate an output value matrix from the output signals of each individual sensing element of the thermographic sensor 20 such that when an anomalous event or activity is identified, the output value matrix is used to validate at least one parameter of a living being relative to the assisted living monitor 70.

The thermographic sensor 20 will typically be used to validate anomalous events or activity relating to a resident rather than other occupants in a space, such as a pet for example.

Information from the thermographic sensor 20 may be used to distinguish between a human resident and other heat sources, for example pets or machines and the like. For example, the information from the thermographic sensor 20 may be used to distinguish between heat sources based on any one or more of: the size of a heat source, the shape of a heat source and temperature of a heat source.

In the context of the present disclosure, the at least one thermographic sensor 20 will typically be used as an alternative to closed-circuit television. Closed-circuit television or any video surveillance equipment will not provide the resident with the privacy to which they are entitled, but the use of a thermographic sensor 20 can allow a large amount of information to be captured in relation to the location of the resident within the monitored area, and other parameters in relation to the resident such as their body position for example, through the use of an optimised definition or resolution of the thermographic sensor 20. In particular, the definition or resolution of the thermographic sensor 20 which will typically be dependent upon the number of sensing elements in the array, can be optimised to provide sufficient information upon which the processing unit 19 can base a decision as to parameters relating to the resident such as size, shape and body position, but at a low enough resolution or definition so as to be limited to those parameters. In this way, the privacy of the resident is maintained because the thermographic sensor 20 typically cannot detect enough information (or at least no visual representation of any detailed information will be produced) to breach the privacy of the resident, but sufficient information can be captured in order to be used as a validation of whether or not an anomalous event requiring assistance has occurred based on the peak to peak noise level.

The thermographic sensor 20 is typically configured to provide an indication of the resident location and/or body position of the resident based on the respective temperatures of the segments within the field of view of the thermographic sensor 20 relative to one another.

The processing unit 19 uses the information from the thermographic sensor 20 to distinguish between heat sources, for example distinguish a resident from a pet from a kettle or oven. Typically, this distinction will be undertaken on the basis of the size and shape of the heat source. Therefore, the processing unit 19, using the information from the thermographic sensor 20, can determine when a resident is in the room, using information such as the size and shape of a heat source but the processing unit 19, using the information from the thermographic sensor 20 can also determine the body position of resident within the room.

In an embodiment, the number of sensing elements provided will typically be configured to provide a block representation of a heat source, only to the degree required to conduct a comparison with one or more preset values in order to identify the nature of the heat source, such as whether the heat source is a resident or another heat source such as a pet or appliance for example.

Information from the thermographic sensor 20 can be used in combination with the peak to peak noise levels from the PDM microphone 18. In an embodiment, the PDM microphone 18 of the assisted-living monitor 70 is used to identify the occurrence of anomalous events based on changes to the peak to peak noise level. The data from the thermographic sensor 20 can then be used to examine the monitored area for the presence of a resident based on the identification of a heat source of the size and shape of the resident for example, and if a resident is present in the room, then the data from the thermographic sensor 20 can be used to determine location and/or body position of the resident which may be indicative of a fall or similar.

In an embodiment, information from the at least one thermographic sensor may be used to electronically produce a visual image (which can be displayed for a user for example), based on the output signals corresponding to the temperature of the corresponding segment. The electronic image will typically be a block image with each block relating to the temperature from one of the array of sensing elements. Each of the blocks may be a pixel with the shade or colour of the pixel representing the temperature in the corresponding segment. Importantly, the preferred block image will be a low-resolution block image sufficient to indicate the location and/or body position of a resident but insufficient to read any relevant details which may breach the privacy of the resident. The block image can be used to provide information in relation to the size and/or shape and/or location and/or body position of a heat source.

An example of a simple block image is shown in FIGS. 29, 31 and 33 which shows a resident standing, sitting and lying on the floor, based on the size and relative positions of the blocks. More detailed block images are shown in FIGS. 26 and 27 which also show body parts such as the resident's arms for example, but still do not include enough detail to breach the privacy of the resident.

The block image can be used to validate the anomalous event or activity by checking for the presence of the resident first and then the location/body position of resident (based on the size and relative positions of the blocks). Use of the information relating to the noise levels from the PDM microphone 18 and the thermographic information from the thermographic sensor 20 will typically increase the accuracy of the assessment of the anomalous event, allowing automated detection of an anomalous event and then categorisation of the anomalous event.

Any type of thermographic sensor 20 could be used. A number of thermographic sensors 20 may be used in a housing or in different housings in the same room (to give different perspectives for cross-checking). As mentioned, typically the number of sensing elements in the array of sensing elements of the at least one thermographic sensor will preferably correspond to the number of blocks in the resolution of the preferred image which is generated.

In an embodiment, the at least one thermographic sensor 20 may collect temperature data in a higher resolution than that used to generate and display the image. The processing unit 19 may use an averaging algorithm if the temperature data is collected in a higher resolution than that to be used to reduce the resolution of any image produced to show size and shape and relative position information but disguise identifying information which may breach the privacy of the resident.

In an embodiment, the output from the at least one thermographic sensor 20 is typically not visible on an interface of a display screen, unless selected. The detection of an anomalous event is typically undertaken at a primary level by the processing unit 19 based on changes in the peak to peak noise levels detected by the PDM microphone 18, and information from the at least one thermographic sensor 20 may then be used to generate an image when an anomalous event is detected by the PDM microphone 18.

The assisted living monitor 70 may further include at least one movement sensor operable to detect movement. The at least one movement sensor will preferably sense movement and provide information to the processing unit of the assisted living monitor. The at least one movement sensor may be the at least one thermographic sensor as the information collected by the at least one thermographic sensor may be used to detect movement of the heat source.

The at least one movement sensor preferably allows determination of physical movement without constant (visual) observation. The at least one movement sensor and/or the processing unit 19 can preferably determine rough distance and speed of movement over time. This may be stored and/or displayed in a line trace for example, which will allow monitoring but maintain privacy for the resident. An example of a line trace is shown in FIG. 26. Movement can be shown in a binary format (either there is movement or there is not) using an icon and displaying the icon in a first colour (green for example) when movement is detected and displaying the icon in a second colour (red for example) when movement is not detected. An example of such an icon is included in FIG. 27.

The movement information can then be used in combination with the output signals corresponding to the temperature from the thermographic sensor 20 (and/or the peak to peak noise levels from the PDM microphone 18) to more accurately characterise an activity or event relating to a resident as an actionable anomalous event or activity, or an anomalous event or activity that does not require action.

The at least one movement sensor will typically be used to categorise or validate anomalous events or activity relating to a resident rather than other occupants in a space, such as a pet for example.

Typically, the at least one movement sensor utilises the Doppler effect to determine movement within the monitored area.

Any type of movement sensor may be used. Any number of movement sensors may be used. Typically, a single movement sensor is used in order to detect movement relative to a single location of the assisted living monitor 70. More than one movement sensor may be used in order to increase the accuracy of the system in detecting movement and/or other information such as the direction of movement for example. A radar sensor may be used. A microwave radar sensor could be used.

As mentioned above, the information from the at least one movement sensor may be used combination with the information from the at least one thermographic sensor to provide more information to the processing unit 19 in order to validate the anomalous event as either an anomalous event in which the resident requires assistance on anomalous event in which the resident does not require assistance.

The at least one movement sensor can detect the mobility of resident which, when coupled with the temperature information from the thermographic sensor 20, may give increased accuracy in identification of the presence of a resident within the monitored area and/or in identifying a resident as a resident as compared to another heat source, which may be similarly shaped but immobile, for example.

Information from the at least one movement sensor will preferably be combined with the peak to peak noise level information collected by the PDM microphone in order to detect the occurrence of an anomalous event and also the source of the anomalous event. Once on anomalous event has been detected and the source of the anomalous event has been detected, the thermographic information can then be used to validate the anomalous event as one in which the resident requires assistance or not.

Therefore, in an embodiment, the information collected from the PDM microphone may be used by itself or preferably in combination with the information from the at least one movement sensor, as basic information to detect the occurrence of an anomalous event and/or the source of the anomalous event, and then the information from the at least one thermographic sensor is preferably used in combination with the basic information to validate the nature of the anomalous event as one in which the resident requires assistance or not.

The processing unit 19 may operate an algorithm which is capable of determining a rough distance of a movement from the at least one movement sensor. The processing unit 19 may be capable of determining a speed of movement based on information collected from the at least one movement sensor.

Typically, all of the components of the assisted living monitor 70 are provided in a housing such as that illustrated in FIGS. 20 to 24. The housing is typically configured to be mounted within a room of an apartment or flat for example of an assisted living facility. Normally, a processing unit 19 is provided on board the assisted living monitor together with the one or more sensors.

An assisted living monitor system is also illustrated in the Figures, comprising at least one assisted living monitor 70 provided in each of at least a living area 11, bedroom 12 and bathroom 13 of a residential area, each assisted living monitor 70 associated with at least one communication pathway, and at least one monitoring system display 17 located externally of the residential area with access to each of the assisted living monitors 70 for the residential area.

A central system controller or server or similar may be provided to which all of the assisted living monitors 70 in an apartment feed information. The central system controller or server may then provide a visual output of the information from each assisted living monitor 70 in an apartment in a summary display 17 located outside the apartment 10.

The position of the assisted living monitor 70 within the room will typically depend upon the room in which it is mounted. For example, when an assisted living monitor is mounted in a living area 11 or a bedroom 12, the assisted living monitor 70 can be mounted in an upper region of the room, preferably relative to a ceiling or an upper position on a wall.

Normally, the assisted living monitor 70 will be oriented in a particular direction. The one or more sensors in the assisted living monitor will typically have a field of view and the assisted living monitor 70 is typically located within the room such that the field-of-view is directed at parts of the room it which a resident would normally use. In an embodiment, an assisted living monitor 70 can be located in a corner of a room. In an embodiment, an assisted living monitor 70 can be located in a central location on a wall and director at commonly used implements within the room such as a bath, toilet a sofa bed and the like. It must be stressed however that the position of the assisted living monitor 70 within the room will be dependent not only on the room, but also the location of furniture within the room or implements within the room and the field-of-view of the one or more sensors.

An example position of an assisted living monitor 70 mounted in a living room 11 is illustrated in FIGS. 3 and 5 with the orientation shown in FIG. 7 and FIG. 6 is an example of what a resident might see in such a configuration. The field of view of the assisted living monitor 70 so mounted is shown in FIG. 4. As shown, the assisted living monitor 70 is directed toward the sofa and dining area of the living room 11.

An example position of an assisted living monitor 70 mounted in a toilet room is illustrated in FIG. 9 which also shows an example of what a resident might see in such a configuration. The field of view of the assisted living monitor 70 so mounted is shown in FIG. 8. As shown, the assisted living monitor 70 is directed toward the toilet pedestal.

An example position of an assisted living monitor 70 mounted in a bathroom 13 is illustrated in FIGS. 10, 12 and 18 and FIG. 13 is an example of what a resident might see in such a configuration. The field of view of the assisted living monitor 70 so mounted is shown in FIG. 11. As shown, the assisted living monitor 70 is directed toward the bath/shower and toilet pedestal of the bathroom 13.

An example position of an assisted living monitor 70 mounted in a bedroom 12 is illustrated in FIGS. 14 and 16 and FIG. 17 is an example of what a resident might see in such a configuration. The field of view of the assisted living monitor 70 so mounted is shown in FIG. 15. As shown, the assisted living monitor 70 is directed toward the bed and dressing area of the bedroom 12.

Information which is sensed by the one or more sensors and/or produced by the processing unit 19 will typically be stored, normally electronically. Typically, the information is stored in a central storage facility which may be in the controller or server room 16 of the apartment and/or in a central facility on or off site.

As shown in FIG. 19, the information which is sensed can be displayed on a display 17 which is external to the apartment 10. For example, an electronic display may be provided immediately adjacent to the door 22 to the resident's apartment 10 and information in relation to the assisted living monitors 70 within the apartment 10 displayed on that display so that staff of the assisted living facility can monitor the activity within the apartment 10 without entry to the apartment and without breaching the privacy of the residents. Normally, a display 17 which is outside an apartment 10 is dedicated to that particular apartment.

As mentioned above, an example interface for an apartment is shown inn FIG. 25. The example interface includes four areas, one for each of a living room, bedroom, utility room and bathroom, each area containing a number of icons to summarise the situation in that room. The icons show a binary (yes/no) indication of noise level, alert, movement detected and a fourth icon showing whether an added pressure sensor (in the living, bedroom and utility room) is active and water running sensor in the bathroom. The interface also has a slide actuatable indicator of whether the resident is in the apartment or out. All of these will typically be lit in one colour when active and a second colour when not active.

Each of the four areas is also selectable/actuable to show details and when selected/actuated, a detailed interface such as that illustrated in FIG. 26 for a living room, is displayed. In that example interface, the thermographic representation is included as well as a line trace of sound level from the PDM microphone and a movement trace. This interface also shows that the emergency call point in the room is inactive and the pressure pad on the chair is active showing the chair is occupied (and seems to have been occupied for some time according to the movement trace).

A central system control may be provided with one or more displays on which information in relation to all the apartments and the facility can be accessed. An example of a back-end central system interface is shown in FIG. 27. This example interface identifies the apartment 30 shows four areas from each apartment with icons similar to that on the detailed interface in FIG. 26 (movement 32, pressure pad 33, and call point 34) as well as a line trace of sound level 31 from the PDM microphone from each room and a ‘menu’ button 35 to show detail. A live view from the thermographic sensor is also shown and an analysis of the acoustic levels in the apartment. A list of on call alert staff 36 is also included. The names of the on call staff are preferably actuable using a ‘one touch’ system to trigger an alert to be sent to the selected staff member.

The system may be able to determine activity as well as location of the resident for example as shown in the room summary on the bottom of FIG. 27 shows that the pressure sensor shows the bed is occupied and the noise trace shows a rhythmic trace indicating that the resident is asleep.

FIGS. 28 to 33 show the degree of detail from the thermographic sensor in an embodiment and how the processing unit is able to determine the body position of a person based on the relative positions of temperature blocks without requiring the use of a camera or similar. It can be seen that the thermographic sensor image (FIGS. 29, 32 and 33) correspond to the body position of a person shown in FIGS. 28, 30 and 32 respectively but do not convey sufficient information to cause any privacy concerns for the person.

The example of the general system architecture shown in FIG. 34 includes a number of monitoring sensors 40 as included in a room/apartment that are linked to an apartment level controller 41. This controller 41 is wirelessly connected via a wireless access point 42 to a network switch 43 and thence to the system computer server or main controller 44. The network switch 43 is also connected to a router 45 to a network 46. A number of staff tablets 47 or smartphones 48 are typically connected to the network 46 but also provided with wireless access via the wireless access points to the apartment level controller 41.

As mentioned above, the assisted living system may be used in association with an emitter unit for use in a sensory room environment, the emitter unit comprising a mounting portion, at least one projector device mounted relative to the mounting portion and at least one light emitting halo located about the at least one projector or a sensory room system. An emitter unit is illustrated in living room 11 in FIGS. 2, 3 and 5 and the bedroom 12 in FIGS. 2, 14 and 16.

The system may be implemented partially using a software application. The software application may have a monitoring subsystem which operates at all times to monitor information collected from each sensor of the assisted living monitor and if more than one assisted living monitor is provided in a system, for each sensor of each assisted living monitor. The monitoring subsystem will typically collect information and display the information on a relevant display. As mentioned above, a display may be provided externally from the apartment in an assisted living facility such as a door display. A central display may display information in relation to more than one apartment (but allow detailed information in relation to each apartment when an apartment is selected).

The software application may have an alert subsystem in order to detect anomalous events. The alert subsystem will typically operate concurrently with the monitoring subsystem. The alert subsystem will typically validate an anomalous event as an event in which a resident of likely to require action or assistance or not. The validation step will typically take place once an anomalous event has been detected.

Information from one or more assisted living monitors may be displayed on a summary interface. The summary interface is preferably provided on a display such as a touchscreen which allows action to be taken in relation to the interface and/or on a conventional screen with appropriate input hardware. The summary interface will typically allow the user to drill down to different apartments within a facility, each room within an apartment, and potentially each sensor in an assisted living monitor provided in a particular room.

Normally, a software application will display a line trace of the peak to peak noise levels collected over time from the PDM microphone. Normally, the software application will display a visual indicator of where the movement is detected by an assisted living monitor. If additional hardware such as pressure pads are provided on one or more chairs or beds for example the software application will typically display a visual indication of information from the pressure pad which typically indicates that a resident is currently sitting/lying on a chair/bed.

The visual indicators or icons may be simple colour code indicators with one colour indicating a positive and another colour indicating a negative as this will allow more information to be displayed in a small area using one or more icons and a colour coding system. An operator or staff member may be able to select a particular room within a particular apartment and then produce a more detailed view of information in relation to that particular room. The more detailed view may include information such as the noise level trace from the PDM microphone, noise level data, movement data and/or thermographic information.

When the system is set to active (Resident is ‘In’ and Carer is ‘Out’) the following conditions will typically cause a trigger event that raises an alert directly on the monitoring screen, and may forwarded to specified recipients via a mobile telephone or tablet or similar, or over push notification email.
Door Sensor detects door open/door close event.
Emergency Push button (either physical button or wearable button) Emergency Push buttons will cause trigger status even when system disarmed.
Sound levels in any particular room/zone exceeds pre-defined levels over a predefined time period. E.g., Continual Sound Level at 60% over 5 Second Period.
Bedroom Specific sensor. If option to monitor is ticked (selected from Bedroom View Window) then bed exit attempts will cause alert trigger.
Bathroom Specific Sensor. Low level dedicated falls sensor with audio triggering. If body heat detected at low level as opposed to seating or standing will cause alert trigger.
All other rooms/zones watch zones can be programmed, E.g., if a resident is in a room corner or particular space when feeling threatened or anxious this can be programmed to raise an alert.
Additional Falls detectors. Each zone can have up to 6 additional falls detector units that trigger an alert If body heat is detected at low level only as opposed to seating or standing. Resident must be in this position for 5 seconds or more.
An alert will be raised if Wearable Heart Rate, Blood Pressure, O₂ saturation are outside predefined limits. Of if the wearable moves outside a specific range distance

Therefore, the information from the PDM microphone will preferably be collected to allow the identification of anomalous events and information from a movement sensor and/or thermographic sensor may be used to give a powerful indicator of the nature of an event and/or additional information on the location and/or body position of the resident.

Use of information from all three types of sensor together will typically allow a more accurate characterisation of an anomalous event once an anomalous event has been detected and provide an indication of whether the resident requires assistance or not without disrupting the resident, and maintaining the privacy without the need for monitoring equipment that produces a visual image of each room such as CCTV.

The one or more embodiments are described above by way of example only. Many variations are possible without departing from the scope of protection afforded by the appended claims.

What is claimed is:

1. An assisted living monitor comprising a pulse density modulation microphone to read noise levels and a processing unit operable to process the noise levels of the pulse density modulation microphone so as to detect changes in noise levels indicative of an anomalous event or activity.

2. (canceled)

3. (canceled)

4. An assisted living monitor as claimed in claim 1, wherein the processing unit compares the noise level to the level at a historical time to determine the anomalous event or activity.

5. (canceled)

6. (canceled)

7. (canceled)

8. An assisted living monitor as claimed in claim 1, further comprising at least one thermographic sensor, 3D Time-of-Flight sensor, LiDAR sensor and/or structured light sensor.

9. An assisted living monitor as claimed in claim 8, wherein the at least one thermographic sensor 3D Time-of-Flight sensor, LiDAR sensor and/or structured light sensor comprises at least one sensing element operable to output at least one signal corresponding to characteristic data of at least one segment within a field of view of the thermographic sensor, 3D Time-of-Flight sensor, LiDAR sensor and/or structured light sensor, the processing unit configured to generate an output value matrix from the output signals of the at least one sensing element such that when an anomalous event or activity is identified, the output value matrix is used to validate at least one parameter of a living being relative to the assisted living monitor.

10. An assisted living monitor as claimed in claim 9, wherein the at least one thermographic sensor has a resolution dependent on the number of sensing elements provided.

11. An assisted living monitor as claimed in claim 9, wherein the at least one thermographic sensor, 3D Time-of-Flight sensor, LiDAR sensor and/or structured light sensor provides an indication of a resident location and/or body position based on the respective characteristic data from the at least one segment within a field of view of the thermographic sensor, 3D Time-of-Flight sensor, LiDAR sensor and/or structured light sensor within the field of view of the thermographic sensor 3D Time-of-Flight sensor, LiDAR sensor and/or structured light sensor.

12. An assisted living monitor as claimed in claim 9, wherein information from the at least one thermographic sensor, 3D Time-of-Flight sensor, LiDAR sensor and/or structured light sensor is used to electronically produce a visual image based on the output signals corresponding to the characteristic data from the at least one segment.

13. An assisted living monitor as claimed in claim 8, wherein information from the pulse density modulation microphone is used to identify the occurrence of anomalous events based on changes to the noise level, and data from the at least one thermographic sensor, 3D Time-of-Flight sensor, LiDAR sensor and/or structured light sensor is then used to detect whether a resident is present, and when a resident is present, then a location and/or body position of the resident.

14. (canceled)

15. An assisted living monitor as claimed in claim 1, further comprising at least one movement sensor to detect physical movement without constant observation.

16. An assisted living monitor or system as claimed in claim 15, wherein information from the at least one movement sensor is used in combination with the peak to peak noise levels from the pulse density microphone to more accurately characterise an anomalous activity or event relating to a resident as an actionable anomalous event or activity, or an anomalous event or activity that does not require action.

17. An assisted living monitor or system as claimed in claim 15, wherein the pulse density modulation microphone is provided in a housing with the at least one movement sensor.

18. (canceled)

19. An assisted living monitor system comprising an assisted living monitor including a pulse density modulation microphone in each of at least a living area, bedroom and bathroom of a residential area, each assisted living monitor associated with at least one communication pathway, a processing unit operable to process the noise levels of the pulse density modulation microphone so as to detect changes in noise levels indicative of an anomalous event or activity and at least one monitoring system display located externally of the residential area with access to each of the assisted living monitors for the residential area.

20. An assisted living monitor system as claimed in claim 19, wherein at least one of the assisted living monitors further comprises at least one thermographic sensor, 3D Time-of-Flight sensor, LiDAR sensor and/or structured light sensor.

21. An assisted living monitor system as claimed in claim 19, wherein at least one of the assisted living monitors further comprises at least one movement sensor.

22. An assisted living monitor system as claimed in claim 20, wherein information from the at least one thermographic sensor, 3D Time-of-Flight sensor, LiDAR sensor and/or structured light sensor and/or the at least one movement sensor is used in combination with the noise levels from the pulse density microphone to more accurately characterise an anomalous activity or event relating to a resident as an actionable anomalous event or activity, or an anomalous event or activity that does not require action.

23. An assisted living monitor system as claimed in claim 19, further comprising at least one pressure pad to be located on a chair or a bed to detect when a resident is seated on the chair or lying on the bed.

24. An assisted living monitor system as claimed in claim 19, further comprising at least one emergency call button provided in a fixed or portable configuration.

25. An assisted living monitor as claimed in claim 1, wherein the pulse density modulation microphone reads peak to peak noise levels to detect changes in noise levels indicative of an anomalous event or activity.

26. An assisted living monitor system comprising an assisted living monitor including a pulse density modulation microphone to read peak to peak noise levels and a processing unit operable to process the peak to peak noise levels of the pulse density modulation microphone so as to detect changes in noise levels indicative of an anomalous event or activity.
